(19) United States
(12) Patent Application Publication
(10) Pub. No.: US 2005/0028911 A1
(43) Pub. Date: Feb. 10, 2005

(54) Rapid access device

(76) Inventors: Thomas P. Canavan, Flower Mound, TX (US); Jeffey D. Montgomery, Plano, TX (US)

Correspondence Address: Paul W. Fulbright;Law Office of Paul W. Fulbright, PLLC, 2003 J J Pearce Drive, Richardson, TX, 75081-5447, US

(21) Appl. No.: 10/636,713

(22) Filed: Aug. 7, 2003

(51) Int. Cl. A45C 1/06; G09F 3/18

(52) U.S. Cl. 150/145; 40/642.02; 150/138; 150/140

(57) ABSTRACT

A rapid access device to facilitate the display of travel documents at travel hubs, such as airports and bus terminals, is disclosed. The device comprises a display support structure featuring at least one central fold which may be offset to facilitate rapid tactile orienting and opening of the device. The device also features at least one large item display panel (for displaying, for example, a boarding pass) and at least one small item display panel (for displaying, for example, an identification card or frequent flyer card). The device also features at least one handling section, defined by the relative location of the display panels and display receptacles, to facilitate the rapid and minimally blocked presentation of the user's travel documents.

### BACKGROUND OF THE INVENTION

Travel is time-consuming. For that reason, everyone associated with the travel industry, be they industry practitioners or the travelers themselves, devotes efforts large and small to minimizing time inefficiently spent on all phases of the traveling process, and these efforts are made regardless of whether the travel be conducted through the air, over ground, or oversea.

One source of lost time is the time spent simply being processed through the numerous administrative and security checkpoints common to a typical airport or bus terminal. For example, even when administrative or security personnel are inclined to pass a passenger rapidly through a checkpoint, time is unnecessarily lost while the passenger endeavors to locate and display his or her boarding pass, picture ID, passport, and/or frequent flyer card. While the time lost appears minimal to the individual passenger, the time lost is substantial when considered in light of the millions of passengers who, quite innocently and unintentionally, burden our transportation systems with these unnecessary delays.

There is thus a clear, present need for a device which frees these passengers, and the transportation hubs through which they traffic, of these unnecessary delays. There is a need for a device which is specifically designed to facilitate the rapid and effective display of items, such as travel documents, at transportation hub checkpoints. It is to the satisfaction of this need that the present disclosure is directed.

### BRIEF SUMMARY OF THE INVENTION

A rapid access device to facilitate the display of travel documents at travel hubs, such as airports and bus terminals, is disclosed. The device comprises a display support structure featuring at least one central fold which may be offset or otherwise fashioned to facilitate rapid tactile orienting and opening of the device.

The device also features at least one large item display panel for displaying, for example, a boarding pass, and at least one small item display panel for displaying, for example, an identification card or frequent flyer card. The device also features at least one handling section, defined by the relative location of the display panels and display receptacles, to facilitate the rapid and minimally blocked presentation of the user's travel documents.

### BRIEF DESCRIPTION OF THE SEVERAL VIEWS OF THE DRAWINGS

FIG. 1 depicts a front view of a first embodiment of a rapid access device.

FIG. 2 depicts a back view of the rapid access device shown in FIG. 1.

FIG. 3 depicts a bottom view of the rapid access device shown in FIG. 1.

FIG. 4 depicts a top view of the rapid access device shown in FIG. 1.

FIG. 5 depicts a left side view of the rapid access device shown in FIG. 1.

FIG. 6 depicts a right side view of the rapid access device shown in FIG. 1.

FIG. 7 depicts the rapid access device shown in FIG. 1 in a closed position in a view which highlights the orienting utility of a surface ornamentation.

FIG. 8 depicts the rapid access device shown in FIG. 1 in a closed position in a view which highlights the utility of cutaways at two corner locations of the device.

FIG. 9 depicts a second embodiment of a rapid access device in a closed position in a view which highlights the utility of an offset fold.

FIG. 10 depicts a third embodiment of a rapid access device featuring two central folds and a second small item display panel.

FIGS. 11A and 11B depict examples of the point of entry for the small item display receptacles utilized in the rapid access device.

FIG. 12 depicts certain aspects of a typical construction of the rapid access devices depicted in FIGS. 1 and 9, similar modes of construction being utilized in the manufacture of the embodiment shown in FIG. 10.

### DETAILED DESCRIPTION OF THE INVENTION

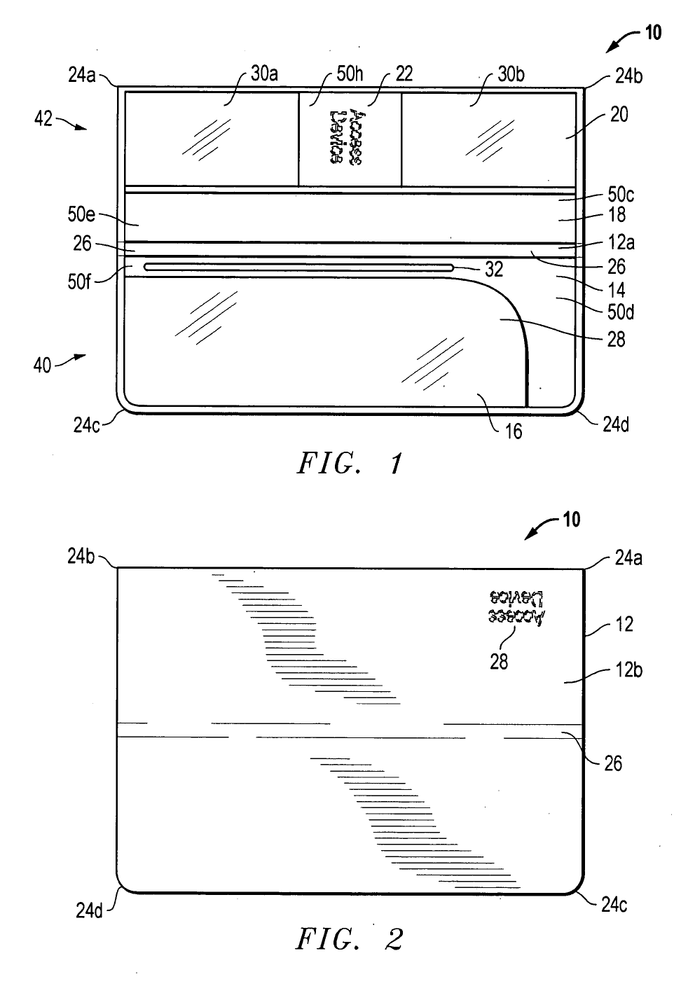

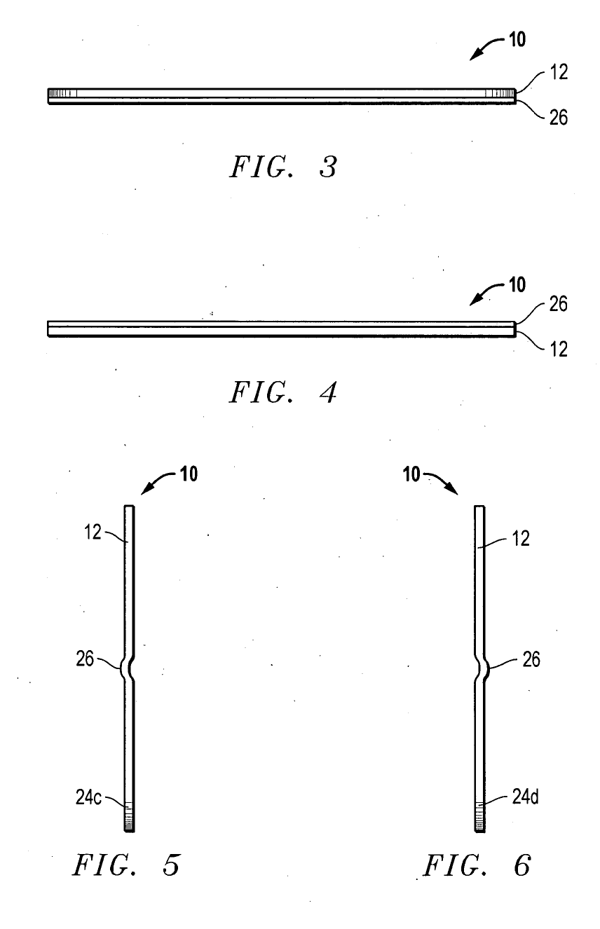

Referring to the Figures, in which similar reference characters depict similar components, a rapid access device 10 is shown. The rapid access device 10 is depicted in three embodiments in FIGS. 1, 9, and 10, with certain useful aspects of construction revealed in FIG. 12, and various useful features highlighted in FIGS. 2-8, 11A, and 11B.

The functionality, use, and ornamental appearance of the rapid access device 10 are best understood with reference to the front view appearance of a first embodiment as shown in FIG. 1.

The rapid access device 10 comprises a display support structure 12 (the front side of which is designated generally as 12a, the back side of which is designated generally as 12b). The display support structure 12, as well as the other non-translucent components of which the rapid access device 10 is constructed, is generally made of high-quality calfskin leather, virgin vinyl, ballistic nylon, cordura, various exotic skins (such as buffalo, alligator, ostrich, or snake) or their functional equivalents.

The display support structure 12 comprises at least one central fold; as shown in FIG. 1, the central fold 26 facilitates the closing the rapid access device 10 so that the display of one or more items (e.g., travel documents) to be displayed is blocked. The reduced size of the rapid access device 10 in its closed position also facilitates convenient and rapid storage and retrieval.

The rapid access device 10 also comprises at least one large item display panel 40 and one small item display panel 42.

In FIG. 1, the large item display panel 40 comprises at least one large item flap display receptacle, which is comprised of the large item flap display receptacle translucent flap 16 and the large item flap display receptacle backing 14 to which it is affixed. The large item flap display receptacle facilitates the display of an elongated item, or large item, such as a boarding pass, placed within the large item flap display receptacle. The flap design facilitates rapid insertion, viewing, and removal of items which are commonly inserted and removed with great frequency, such as a boarding pass. The flap is sufficiently translucent (and all device components described as translucent are designed to be sufficiently translucent) that a barcode scanner can reliably read barcode symbols through it. Although the flap design is preferred, the large item display panel could utilize receptacles featuring the alternative designs disclosed elsewhere herein.

In FIG. 1, the small item display panel 42 comprises two small item display receptacles 30a, 30b which are formed from the small item display receptacle frame 22 (see also reference character 22′ in FIG. 12), the small item display receptacle translucent shield 20, and the small item display receptacle backing 18 to which the small item display receptacle frame 22 and small item display receptacle translucent shield 20 are affixed. The small item display receptacles 30a, 30b facilitate the display of diminutive items, or small items, such as an identification card, placed within the small item display receptacle 30a, 30b. Generally, two sides (opposite sides), and preferably three sides, are sealed to secure the item. The constrained enclosure facilitates secure viewing, and it also facilitates the occasional insertion and removal of items which are less commonly inserted and removed from the small item display receptacle 30a, 30b, such as an identification card or frequent flyer card. Although the enclosed design is preferred, the small item display panel 42 could utilize receptacles featuring the alternative designs, such as the flap designs, disclosed elsewhere herein.

Finally, the device 10 comprises at least one handling section. The rapid access device 10 is oversized relative to the items it displays for an important reason: its primary purpose is the rapid and effective display of a select number of items which are heavily used at travel hubs. Thus, throughout the Figures, locations at which the user can grip and hold out the rapid access device 10 for clear viewing are designated as example handling sections 50a-50h (in FIG. 1, handling sections 50c, 50d, 50e, 50f, and 50h are highlighted). The handling sections 50 are defined by the relative location of the display panels 40, 42, 44″ and display receptacles on the display support structure 12, and these handling sections 50 derive their utility from facilitating the presentation of the rapid access device 10 (and the items contained therein) while minimally blocking the items being displayed.

FIGS. 2-6 show the back, bottom, top, left side and right side views of the rapid access device 10 shown in FIG. 1.

Returning to FIG. 1, it is revealed that the rapid access device 10 of FIG. 1 further comprises an item display support slot 32. The item display support slot 32 is optionally included, for example, for travelers who frequently travel internationally and who need a convenient locus for an item, such as a passport (which itself usually features a single central fold), that can be partially inserted in a conveniently located slot in the rapid access device 10.

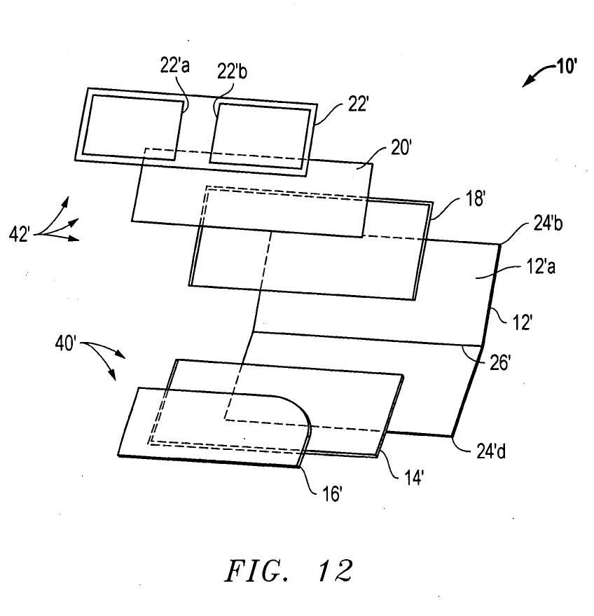

FIG. 2 reveals one use of surface ornamentation, namely the use of asymmetric surface ornamentation 28, to accomplish the important utilitarian function of facilitating rapid, proper orientation of the rapid access device 10. Surface ornamentation 28, because it is asymmetric, can be prominently located anywhere on the back side 12b of the rapid access device 10 and its objective will be fulfilled. An alternative use of surface ornamentation in the invention lays in the use of a small surface ornamentation on a small item display receptacle, such as small item display receptacles 30a, 30b, to visually cue the audience as to the side of the receptacle from which the item is to be removed (see generally FIG. 11A and FIG. 11B). The surface ornamentation could be as simple as an arrow embossed upon the small item display receptacle translucent shield 20 pointing to the side of the small item display receptacle 30a, 30b from which the item is to be removed.

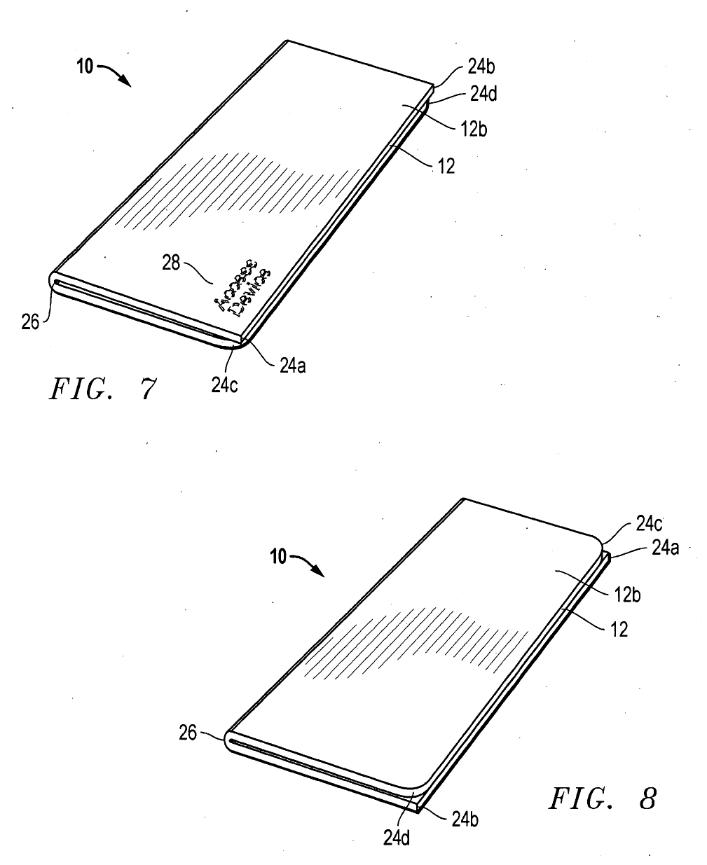

FIG. 7 and FIG. 8 demonstrate the use of two cutaways 24c, 24d in the rapid access device 10 of FIG. 1. A close examination of FIG. 1 reveals that the rapid access device 10 features two rounded corners, or cutaways 24c, 24d. These cutaways 24c, 24d facilitate the rapid opening of the rapid access device 10 in its correct orientation, because they enable the user to use tactile input alone to properly orient the rapid access device 10 before rapidly and easily opening it. The protruding corners 24a, 24b are contrasted to the cutaways 24c, 24d in FIG. 7 and FIG. 8. It is worth noting that, while cutaways are shown at two corners of the rapid access device 10 in FIGS. 1-8, a single cutaway would be equally effective, and this cutaway could even be located along an edge of the device, rather than at a corner as shown.

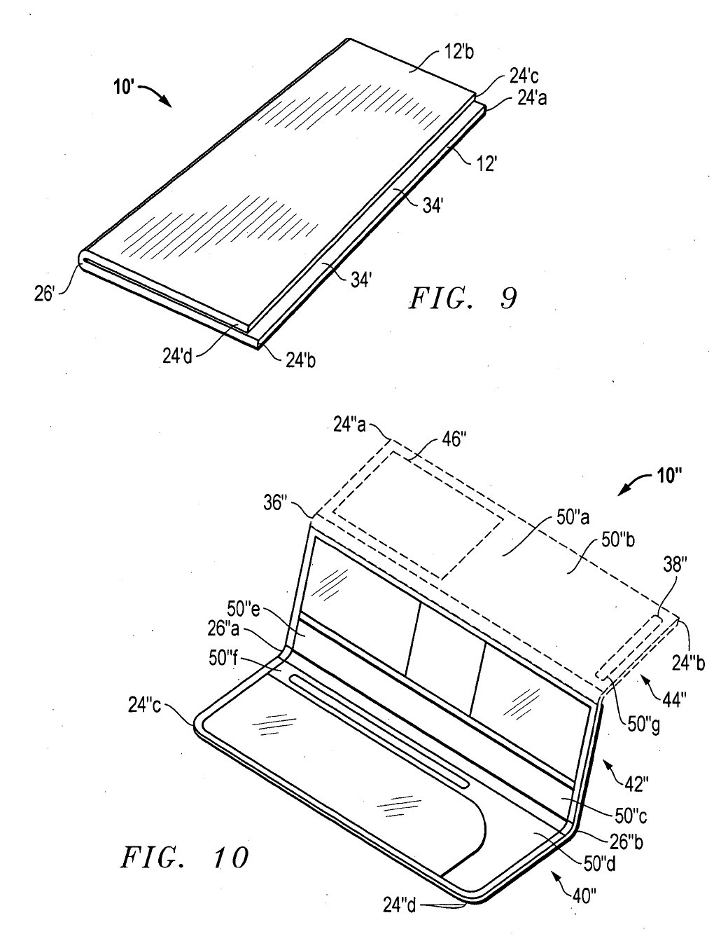

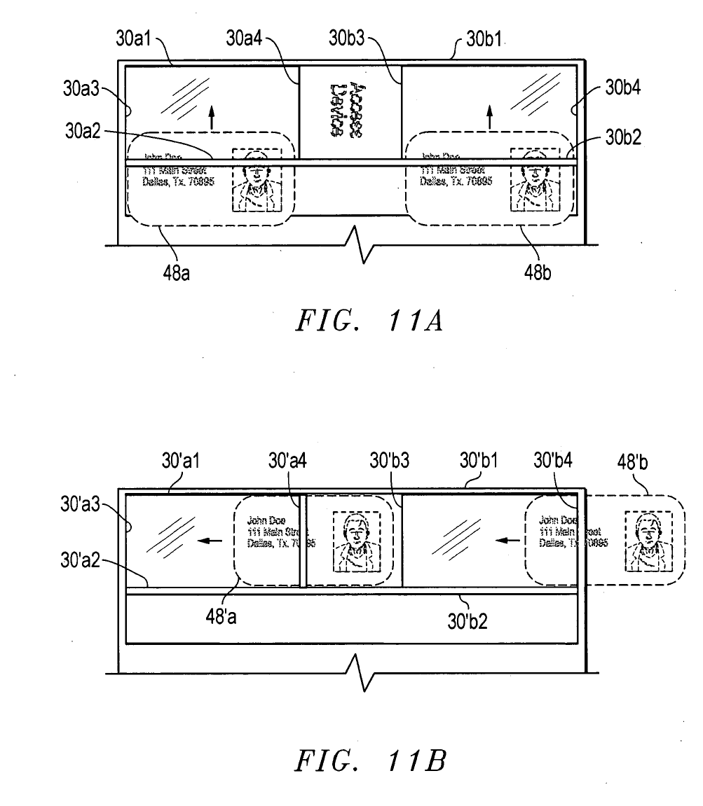

FIG. 9 depicts a second embodiment of the invention, rapid access device 10′, an embodiment which features the use of an offset fold 26′ to produce an offset 34′. Concisely stated, the rapid access device 10′ of FIG. 9 is in all respects similar to the rapid access device 10 of FIG. 1 except that the rapid access device 10′ features a central fold 26′ that is displaced from center, so that, when the rapid access device 10′ is closed, the top portion of the device (i.e., the uppermost portion of the device when it is displayed vertically) overhangs (or, is offset from) the bottom portion of the device. As in the case of the cutaways 24c, 24d of the first embodiment, the offset 34′, which results from the offset fold 26′, facilitates the tactile orientation of the rapid access device 10′, as well as the rapid opening and use of the rapid access device 10′.

FIG. 11A demonstrates that the small item display receptacles 30a, 30b are typically to be sealed on three sides, so that they are top-opening (i.e., configured to receive an item, such as an identification card, from the top edge 30a1, 30b1 when the rapid access device is vertically presented), interior-side-opening (i.e., configured to receive an item from the side edge 30a4, 30b3 closest to the central interior of the rapid access device), exterior-side-opening (i.e., configured to receive an item from the side edge 30a3, 30b4 farthest from the central interior of the rapid access device), or bottom-opening (i.e., configured to receive an item from the bottom edge 30a2, 30b2 when the rapid access device is vertically presented).

FIG. 11A depicts a small item display receptacle 30a that is bottom-opening along edge 30a2. FIG. 11A also depicts a small item display receptacle 30b that is bottom-opening along edge 30b2. FIG. 11B, by contrast, depicts a small item display receptacle 30′a that is interior-side-opening along edge 30′a4. FIG. 11B also depicts a small item display receptacle 30′b that is exterior-side-opening along edge 30′b4.

There are unique advantages and disadvantages specific to the use of top-, interior-side-, exterior-side-, and bottom-opening small item display receptacles.

Top-opening small item display receptacles constitute the easiest and most natural presentation of an item and one which makes removal of the item from the receptacle maximally convenient. The item displayed is also least likely to fall out of the receptacle when the rapid access device 10 is vertically displayed. However, when the rapid access device is closed, and in an inverted-U orientation relative to the ground, it is possible for the item in the small item display receptacle to fall out. Thus, in the manufacture of this embodiment, it becomes important for the receptacle to be tightly fitted so that frictional effects alone generally secure the item in place.

Bottom-opening small item display receptacles feature a contrasting set of advantages and disadvantages. When the rapid access device is closed, the item to be displayed is least likely to fall out due to the presence of the central fold. However, when the rapid access device is opened, and presented in its usual vertical orientation relative to the ground, it is possible for the item in the small display receptacle to fall out. See generally FIG. 11A. Thus, in the manufacture of this embodiment, it also becomes important for the receptacle to be tightly fitted so that frictional effects secure the item in place.

Interior-side-opening small item display receptacles minimize the probability that items will fall out of the receptacles either during storage or use. See FIG. 11B at small item display receptacle 30′a. However, they can be the least convenient, particularly when two small item display receptacles, both featuring interior-side-opening, are positioned side-by-side. In such a case, the user must remove one card and only then the other, in series, because crowding occurs if both are removed simultaneously towards the center of the rapid access device.

Exterior-side-opening small item display receptacles maximize convenience. See FIG. 11B at small item display receptacle 30′b. However, they do so at a slightly higher risk that items will fall out of the receptacles either during storage or use. In the manufacture of this embodiment, therefore, it is also important for the receptacle to be tightly fitted so that frictional effects secure the item in place.

FIG. 12 reveals select details associated with a typical mode of construction of the rapid access device disclosed herein. In FIG. 12, the main components of construction of rapid access device 10′ are disclosed.

The large item display panel 40′ comprising a large item flap display receptacle is shown as comprising the large item flap display receptacle translucent flap 16′ and the large item flap display receptacle backing 14′ to which it is affixed. The large item display panel 40′ is affixed to the structure 12′ on face 12′a, the details of the method of affixation (e.g., sewing, adhesive) being left to persons of ordinary skill in the field. Typically, the large item display panel 40′ components are affixed in such a way that they are not visible when the invention is viewed from the side; hence, the side views of FIG. 5 and FIG. 6 do not show these components.

The small item display panel 42′ comprises the small item display receptacle frame 22′ (with opening 22′a and opening 22′b), the small item display receptacle translucent shield 20′, and the small item display receptacle backing 18′ to which the small item display receptacle frame 22′ and small item display receptacle translucent shield 20′ are affixed, the details of the method of affixation (e.g., sewing, adhesive) being left to persons of ordinary skill in the field. Typically, the small item display panel 42′ components are affixed in such a way that they are not visible when the invention is viewed from the side; hence, the side views of FIG. 5 and FIG. 6 do not show these components.

It is important to note that, typically, the large item flap display receptacle backing 14′ and the small item display receptacle backing 18′ do not together cover the entirety of surface 12′a. Rather, a small rectangular strip of surface 12′a continues to be exposed at the central fold 26′ (central fold 26′ being an offset fold as discussed above). See also FIG. 1 at central fold 26. If, in FIG. 1 and FIG. 12, the lower edge of small item display receptacle backing 18′ were left unsealed (or, unsecured), then it would be possible for the user to store personal effects, such as documents, cash, or cards, behind the small item display panel 42. Additional storage space becomes available if the upper edge of the large item flap display receptacle backing 14′ is similarly left unsecured. However, in practice, when substantial numbers of items are stored in this manner, the utility of the rapid access device 10′ as an extremely portable, rapid and effective display device is reduced. The utility of the rapid access device 10′ is thus maximized if at least one, or, most preferably, all of the display panels 40′, 42′ are secured so as to prevent storage of items behind the display panel.

FIG. 10 depicts a rapid access device 10″ comprising a display support structure 12″ comprising at least two central folds 26″, 36″. In short, an additional small item display panel 44″ has been added featuring a single small item display receptacle 46″ (to display for example a third identification card), an item display support slot 38″, and a generous number of additional handling sections 50″. The cutaways 24″c, 24″d mainly facilitate folding of this three-panel embodiment, and the use of offset folds at central fold 26″ and central fold 36″ create an offset fold structure (i.e., a structure such that, when the rapid access device 10″ is closed, an offset is presented to facilitate rapid tactile gripping and opening of the rapid access device 10″ by means of an opening grip upon panel 44″).

All of the features discussed with regard to the previous embodiments may be applied to this third embodiment. Use of secured display panels 40″, 42″, 44″ to prevent storage of items behind the display panels is particularly recommended in order to prevent “packing” of the device with cash, documents, or cards which would impede closure, storage, and rapid and convenient deployment.

Although the device has been shown and described herein in a variety of specific embodiments, the description is not a limiting one. Rather, the metes and bounds of the invention should be apprehended with reference to the claims which follow, the claims being interpreted in accordance with the law and, where appropriate, in accordance with interpretive doctrines such as the doctrine of equivalence.

1. A rapid access device comprising:
(a) a display support structure comprising at least one central fold to facilitate the closing the rapid access device and the blocking of the display of one or more items to be displayed by means of the rapid access device;
(b) at least one large item display panel, said large item display panel comprising at least one large item flap display receptacle, said large item display panel affixed to said display support structure to facilitate display of a large item placed within said large item flap display receptacle;
(c) at least one small item display panel, said small item display panel comprising at least one small item display receptacle, said small item display panel affixed to said display support structure to facilitate display of a small item placed within said small item display receptacle; and
(d) at least one handling section, said handling section defined by the relative location of said display panels and display receptacles on said display support structure, said handling section facilitating the minimally blocked presentation of the display receptacles and said items contained within said display receptacles.

2. The rapid access device of claim 1 further comprising at least one cutaway to facilitate the opening of said rapid access device.

3. The rapid access device of claim 1 further comprising an offset fold to facilitate the opening of said rapid access device.

4. The rapid access device of claim 1 wherein at least one of said small item display receptacles is top-opening.

5. The rapid access device of claim 1 wherein at least one of said small item display receptacles is interior-side-opening.

6. The rapid access device of claim 1 wherein at least one of said small item display receptacles is exterior-side-opening.

7. The rapid access device of claim 1 wherein at least one of said small item display receptacles is bottom-opening.

8. The rapid access device of claim 1 further comprising an item display support slot.

9. The rapid access device of claim 1 further comprising a surface ornamentation to facilitate the oriented opening of the rapid access device.

10. The rapid access device of claim 1 further comprising a surface ornamentation on at least one display panel receptacle to facilitate efficient removal of said item from said display panel receptacle.

11. The rapid access device of claim 1 wherein at least one display panel is secured to said display support structure so as to prevent storage of items behind said one or more display panels.

12. The rapid access device of claim 1 wherein all display panels are secured to said display support structure so as to prevent storage of items behind said display panels.

13. A rapid access device comprising:
(a) a display support structure comprising at least one central fold, said central fold constituting an offset fold, to facilitate both the oriented opening and the closing the rapid access device, said closing to block the display of one or more items to be displayed by means of the rapid access device;
(b) at least one large item display panel, said large item display panel comprising at least one large item flap display receptacle, said large item display panel affixed to said display support structure to facilitate display of a large item placed within said large item flap display receptacle;
(c) at least one small item display panel, said small item display panel comprising at least one small item display receptacle, said small item display panel affixed to said display support structure to facilitate display of a small item placed within said small item display receptacle;
(d) at least one handling section, said handling section defined by the relative location of said display panels and display receptacles on said display support structure, said handling section facilitating the minimally blocked presentation of the display receptacles and said items contained within said display receptacles; and
(e) a surface ornamentation on said rapid access device to facilitate the oriented opening of the rapid access device.

14. The rapid access device of claim 13 wherein at least one of said small item display receptacles is top-opening.

15. The rapid access device of claim 14 further comprising a surface ornamentation on at least one display panel receptacle to facilitate efficient removal of said item from said display panel receptacle.

16. The rapid access device of claim 13 wherein all display panels are secured to said display support structure so as to prevent storage of items behind said display panels.

17. The rapid access device of claim 16 wherein at least one of said small item display receptacles is top-opening and said rapid access device further comprises a surface ornamentation on at least one display panel receptacle to facilitate efficient removal of an item from said display panel receptacle.

18. A rapid access device comprising:
(a) a display support structure comprising at least two central folds, said central folds constituting an offset fold structure, to facilitate both the oriented opening and the closing the rapid access device, said closing to block the display of one or more items to be displayed by means of the rapid access device;
(b) at least one large item display panel, said large item display panel comprising at least one large item flap display receptacle, said large item display panel affixed to said display support structure to facilitate display of a large item placed within said large item flap display receptacle;
(c) a first small item display panel, said first small item display panel comprising at least one small item display receptacle, said first small item display panel affixed to said display support structure to facilitate display of a small item placed within said small item display receptacle;
(d) a second small item display panel, said second small item display panel comprising at least one small item display receptacle, said second small item display panel affixed to said display support structure to facilitate display of a small item placed within said small item display receptacle; and
(e) at least one handling section, said handling section defined by the relative location of said display panels and display receptacles on said display support structure, said handling section facilitating the minimally blocked presentation of the display receptacles and said items contained within said display receptacles.

19. The rapid access device of claim 18 wherein at least one of said small item display receptacles is top-opening.

20. The rapid access device of claim 19 wherein all display panels are secured to said display support structure so as to prevent storage of items behind said display panels.
